(19) United States
(12) Patent Application Publication
(10) Pub. No.: US 2026/0113830 A1
(43) Pub. Date: Apr. 23, 2026

(54) EXTREME ULTRAVIOLET LIGHT GENERATION APPARATUS, DROPLET GENERATION CONTROL METHOD, AND ELECTRONIC DEVICE MANUFACTURING METHOD

(71) Applicant: Gigaphoton Inc., Oyama-shi (JP)

(72) Inventors: Shogo KITASAKA, Oyama-shi (JP); Hiroki SUZUKI, Oyama-shi (JP); Yuichi NISHIMURA, Oyama-shi (JP)

(73) Assignee: Gigaphoton Inc., Oyama-shi (JP)

(21) Appl. No.: 19/321,766

(22) Filed: Sep. 8, 2025

(30) Foreign Application Priority Data
Oct. 18, 2024 (JP) 2024-184268

(51) Int. Cl. H05G 2/00

(52) U.S. Cl. CPC H05G 2/0027; H05G 2/0023; H05G 2/0082

(57) ABSTRACT

An extreme ultraviolet light generation apparatus generating extreme ultraviolet light by irradiating a droplet with laser light includes a tank storing a target substance in a liquid state; a nozzle outputting the target substance stored in the tank; a piezoelectric element applying vibration reflecting an electric signal to the target substance to be output from the nozzle to generate the droplet of the target substance; a first sensor measuring a passage interval of the droplets output from the nozzle; a second sensor measuring a parameter related to the droplet; and a processor setting a prohibited band of a duty of the electric signal based on data in which the duty and the parameter at the duty are associated with each other, and setting the duty of the electric signal to be applied to the piezoelectric element while avoiding the prohibited band.

### CROSS-REFERENCE TO RELATED APPLICATIONS

The present application claims the benefit of Japanese Patent Application No. 2024/184268, filed on Oct. 18, 2024, the entire contents of which are hereby incorporated by reference.

### BACKGROUND

### 1. Technical Field

The present disclosure relates to an extreme ultraviolet light generation apparatus, a droplet generation control method, and an electronic device manufacturing method.

### 2. Related Art

Recently, miniaturization of a transfer pattern in optical lithography of a semiconductor process has been rapidly proceeding along with miniaturization of the semiconductor process. In the next generation, microfabrication at 10 nm or less will be required. Therefore, it is expected to develop a semiconductor exposure apparatus combines an apparatus for that generating extreme ultraviolet (EUV) light having a wavelength of about 13 nm with a reduced projection reflection optical system. As the EUV light generation apparatus, a laser produced plasma (LPP) type apparatus using plasma generated by irradiating a target substance with laser light has been developed.

### LIST OF DOCUMENTS

### Patent Documents

Patent Document 1: U.S. Pat. No. 10,225,917
Patent Document 2: U.S. Pat. No. 7,154,922

### SUMMARY

An extreme ultraviolet light generation apparatus according to an aspect of the present disclosure is configured to generate extreme ultraviolet light by irradiating a droplet with laser light and includes a tank configured to store a target substance in a liquid state; a nozzle configured to output the target substance stored in the tank; a piezoelectric element configured to apply vibration reflecting an electric signal to the target substance to be output from the nozzle to generate the droplet of the target substance; a first sensor configured to measure a passage interval of the droplets output from the nozzle; a second sensor configured to measure a parameter related to the droplet; and a processor configured to set a prohibited band of a duty of the electric signal based on data in which the duty and the parameter at the duty are associated with each other, and set the duty of the electric signal to be applied to the piezoelectric element while avoiding the prohibited band.

A droplet generation control method, according to an aspect of the present disclosure, with an extreme ultraviolet light generation apparatus is configured to generate extreme ultraviolet light by irradiating a droplet with laser light. The method includes generating the droplet of a target substance by applying an electric signal to a piezoelectric element to apply vibration reflecting the electric signal to the target substance in a liquid state to be output from the nozzle; measuring a passage interval of the droplets output from the nozzle by a first sensor; measuring a parameter related to the droplet by a second sensor different from the first sensor; setting a prohibited band of a duty of the electric signal based on data in which the duty and the parameter at the duty are associated with each other; and setting the duty of the electric signal to be output to the piezoelectric element while avoiding the prohibited band.

An electronic device manufacturing method according to an aspect of the present disclosure includes generating extreme ultraviolet light using an extreme ultraviolet light generation apparatus, outputting the extreme ultraviolet light to an exposure apparatus, and exposing a photosensitive substrate to the extreme ultraviolet light in the exposure apparatus to manufacture an electronic device. Here, the extreme ultraviolet light generation apparatus is configured to generate the extreme ultraviolet light by irradiating a droplet with laser light, and includes a tank configured to store a target substance in a liquid state; a nozzle configured to output the target substance stored in the tank; a piezoelectric element configured to apply vibration reflecting an electric signal to the target substance to be output from the nozzle to generate the droplet of the target substance; a first sensor configured to measure a passage interval of the droplets output from the nozzle; a second sensor configured to measure a parameter related to the droplet; and a processor configured to set a prohibited band of a duty of the electric signal based on data in which the duty and the parameter at the duty are associated with each other, and set the duty of the electric signal to be applied to the piezoelectric element while avoiding the prohibited band.

An electronic device manufacturing method according to an aspect of the present disclosure includes generating extreme ultraviolet light using an extreme ultraviolet light generation apparatus, inspecting a defect of a reticle by irradiating the reticle with the extreme ultraviolet light, selecting a reticle using a result of the inspection, and exposing and transferring a pattern formed on the selected reticle onto a photosensitive substrate. Here, the extreme ultraviolet light generation apparatus is configured to generate the extreme ultraviolet light by irradiating a droplet with laser light, and includes a tank configured to store a target substance in a liquid state; a nozzle configured to output the target substance stored in the tank; a piezoelectric element configured to apply vibration reflecting an electric signal to the target substance to be output from the nozzle to generate the droplet of the target substance; a first sensor configured to measure a passage interval of the droplets output from the nozzle; a second sensor configured to measure a parameter related to the droplet; and a processor configured to set a prohibited band of a duty of the electric signal based on data in which the duty and the parameter at the duty are associated with each other, and set the duty of the electric signal to be applied to the piezoelectric element while avoiding the prohibited band.

### BRIEF DESCRIPTION OF THE DRAWINGS

Embodiments of the present disclosure will be described below merely as examples with reference to the accompanying drawings.

FIG. 1 is a schematic diagram showing the configuration for measuring a droplet passage interval.

FIG. 2 is a schematic diagram of an output signal of a light receiving element of a droplet detection sensor.

FIG. 3 is a diagram showing an example of an electric signal to be applied to a piezoelectric element.

FIG. is a diagram 4 schematically showing a configuration example of an LPP EUV light generation system according to a comparative example.

FIG. 5 is a flowchart showing main flow of operation of an EUV light generation apparatus.

FIG. 6 is a flowchart showing an example of a DL combining adjustment subroutine applied to step S3 in FIG. 5.

FIG. 7 is a graph showing an example of a DL passage interval σ measured in the DL combining adjustment.

FIG. 8 is a flowchart showing an example of the DL combining control subroutine applied to step S4 in FIG. 5.

FIG. 9 is a graph for explaining the process of changing Duty in a performance improving direction.

FIG. 10 is a graph showing an example of change in the DL passage interval σ and the Duty with respect to control time in the DL combining control.

FIG. 11 is a graph showing an example of DL position shift derived from the piezoelectric Duty.

FIG. 12 is a graph showing the EUV performance when the DL position shift occurs.

FIG. 13 is a graph, showing the DL position shift derived from the piezoelectric Duty.

FIG. 14 is a schematic diagram of DL generation operation corresponding to a portion surrounded by each of surrounding frame lines in FIG. 13.

FIG. 15 schematically shows the configuration of the EUV light generation apparatus according to a first embodiment.

FIG. 16 is an example of an image for detecting the droplet position as image data acquired via a DL position sensor.

FIG. 17 shows an example of piezoelectric Duty operation in the EUV light generation apparatus.

FIG. 18 is a flowchart showing an example of the DL combining adjustment subroutine according to the first embodiment.

FIG. 19 is a graph showing an example of prohibited Duty that is set based on data indicating the relationship between the piezoelectric Duty and the DL position deviation.

FIG. 20 is a flowchart showing an example of the DL combining control subroutine applied to step S4 in FIG. 5.

FIG. 21 is a conceptual diagram of operation in which setting to the piezoelectric Duty is prohibited.

FIG. 22 is a flowchart showing an example of the DL combining control subroutine according to a modification of the first embodiment.

FIG. 23 schematically shows a configuration example of the EUV light generation apparatus according to a second embodiment.

FIG. 24 is a flowchart showing main flow of operation of the EUV light generation apparatus.

FIG. 25 is a flowchart showing an example of the DL combining control subroutine based on EUV light applied to step S6.

FIG. 26 is a graph showing the relationship between the Duty acquired in step S73 and an index value based on CE.

FIG. 27 is a graph for explaining the process of changing the Duty in the improving direction.

FIG. 28 is a graph showing an example of a CE measurement value, a CE difference, and a frequency distribution of the CE difference in a case that combining failure of the DL is occurring.

FIG. 29 is a graph showing an example of the CE measurement value, the CE difference, and the frequency distribution of the CE difference in a case that combining of the DL is normal.

FIG. 30 is a diagram schematically showing the configuration of an exposure apparatus connected to the EUV light generation apparatus.

FIG. 31 is a diagram schematically showing the configuration of an inspection apparatus connected to the EUV light generation apparatus.

### DESCRIPTION OF EMBODIMENTS

### <Contents>

1. Description of terms
   1.1 DL passage interval σ
   1.2 Duty
2. Outline of EUV light generation system according to comparative example
   2.1 Configuration
   2.2 Operation
      2.2.1 Example of DL combining adjustment
      2.2.2 Example of DL combining control
   2.3 Problem
   2.4 Mechanism by which DL position shift occurs (mechanism of problem)
3. First Embodiment
   3.1 Configuration
   3.2 Operation
      3.2.1 Example of DL combining adjustment
      3.2.2 Example of DL combining control
   3.3 Effect
   3.4 Modification
      3.4.1 Configuration
      3.4.2 Operation
      3.4.3 Effect
4. Second Embodiment
   4.1 Configuration
   4.2 Operation
   4.3 Example of index value based on CE
   4.4 Effect
5. Combination of indices determining prohibited Duty
6. Electronic device manufacturing method
7. Processor
8. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Description of Terms

1.1 DL passage interval σ

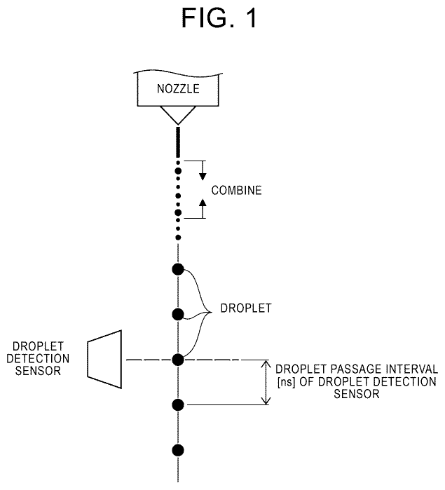

FIG. 1 is a schematic diagram showing the configuration for measuring a droplet passage interval σ being a time interval of droplet passage. FIG. 1 shows a nozzle that ejects a target substance, droplets formed by the target substances ejected from the nozzle, and a droplet detection sensor being a timing sensor that detects a timing at which the droplet passes. The droplet detection sensor is arranged facing a position through which the droplet passes. The droplet detection sensor includes a light receiving element (not shown), and detects change in the output voltage of the light receiving element caused by passage of the droplet. A light emission trigger detection threshold for light emission trigger of a pulse laser device is set for the voltage of the light receiving element. The droplet detection sensor may include an illumination light source (not shown) for illuminating the droplet.

A “droplet” is a form of a target supplied into a chamber. The droplet may refer to a droplet-shaped target having a substantially spherical shape due to surface tension of a molten target substance. In the present specification and drawings, the expression “DL” is an abbreviation of a “droplet”.

The jet of the target substance ejected from the nozzle is separated into droplets, and a plurality of droplets is combined to form a DL. The normally-output DL obtained by combining a specified number of droplets creates a relatively large shadow. Therefore, when the normally-output DL passes beside the droplet detection sensor, the voltage of the light receiving element is greatly reduced. As a result, the voltage of the light receiving element falls below the light emission trigger detection threshold, causing a trigger start point of the pulse laser device.

On the other hand, depending on DL generation conditions, the DL having insufficient combining number and the droplet having no combining occur. Although the shadow due to the DL with combining failure is small and the voltage drop of the light receiving element is small, the voltage of the light receiving element may fall below the light emission trigger detection threshold to cause the trigger start point of the pulse laser device.

In order to avoid such an event, a DL generation condition is determined using a detection interval (hereinafter, referred to as a “DL passage interval”) of a signal indicating the voltage of the light receiving element falling below the light emission trigger detection threshold as an index. Since the DL passage interval becomes a predetermined DL generation cycle when DL combining is normal, the DL combining is evaluated by an index of a DL passage interval variation σ calculated by the following Expression 1.

$$DL passage interval variation σ = \sqrt{\frac{1}{n} {\sum }_{i = 1}^{n} {( Ii - Iave )}^{2}} \qquad [ Expression 1 ]$$

In Expression 1, n is the number of calculation samples, Ii is the i-th DL passage interval, and Iave is the average of the DL passage intervals for the number of calculation samples. Hereinafter, the DL passage interval variation σ is referred to as a “DL passage interval σ”. The unit of the DL passage interval σ is, for example, nanosecond [ns].

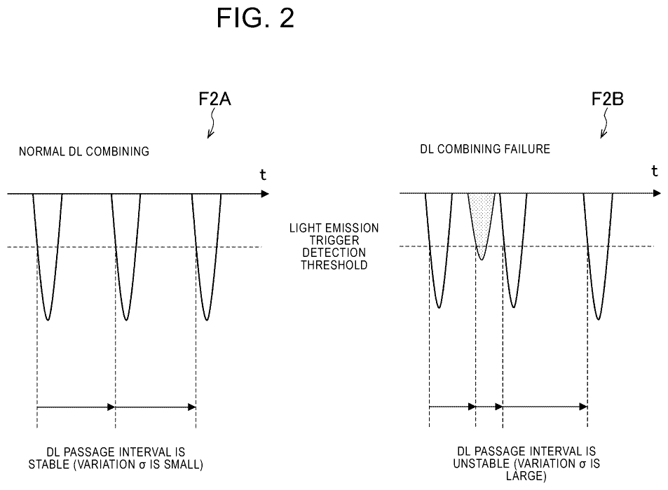

FIG. 2 is a schematic diagram of an output signal (passage timing signal) of the light receiving element of the droplet detection sensor. In FIG. 2, the horizontal axis represents time, and the vertical axis represents, for example, a voltage. FIG. F2A on the left side of FIG. 2 shows a case in which the DL passage interval is stable. Further, FIG. F2B on the right side of FIG. 2 shows a case in which the DL passage interval is unstable. When the DL combining is normal, the DL passage interval is stable and the DL passage interval σ is small, as in FIG. F2A on the left side. On the other hand, when the DL combining is abnormal, the DL passage interval is unstable and the DL passage interval σ is large, as shown in FIG. F2B on the right side.

### 1.2 Duty

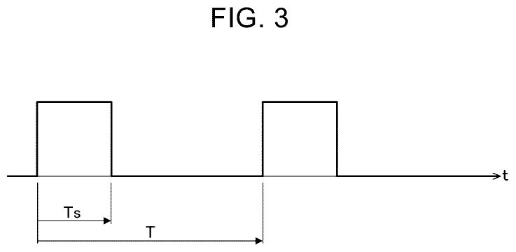

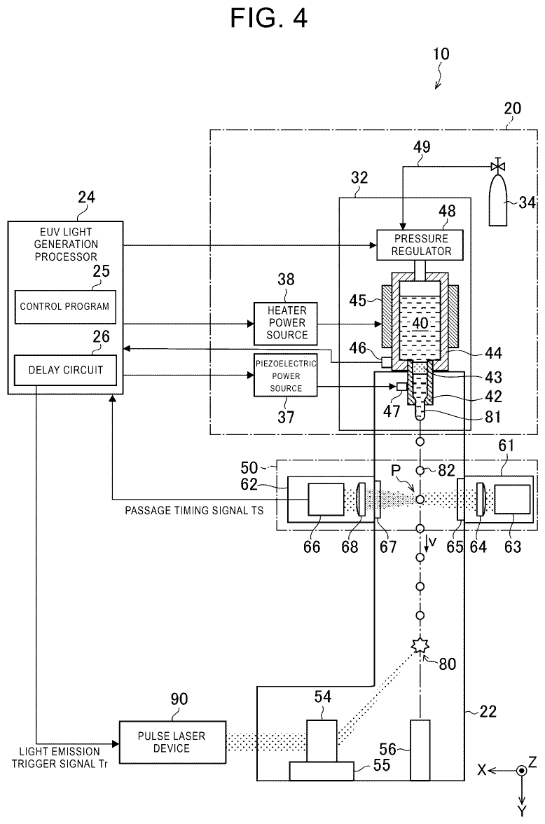

FIG. 3 is a diagram showing an example of an electric signal to be applied to the piezoelectric element for generating a droplet. FIG. 3 shows an example of a rectangular wave having a predetermined cycle. In FIG. 3, the horizontal axis represents time, and the vertical axis represents the voltage. “Duty” is a ratio [%] of an on time (high potential voltage time) Ts in one rectangular wave cycle T.

### 2. Outline of EUV Light Generation System According to Comparative Example

### 2.1 Configuration

FIG. 4 is a diagram schematically showing a configuration example of an LPP EUV light generation system according to a comparative example. The comparative example of the present disclosure is an example recognized by the applicant as known only by the applicant, and is not a publicly known example admitted by the applicant. The expression “EUV light” is an abbreviation for “extreme ultraviolet light”.

An EUV light generation apparatus 10 includes a target generation system 20, a chamber 22, an EUV light generation processor 24, and a droplet detection device 50. The EUV light generation apparatus 10 is used together with a pulse laser device 90. In the present disclosure, a system including the EUV light generation apparatus 10 and the pulse laser device 90 is referred to as the EUV light generation system.

The target generation system 20 includes a target supply unit 32, an inert gas supply unit 34, a piezoelectric power source 37, and a heater power source 38.

The target supply unit 32 includes a nozzle 42 having a hole for outputting a molten target substance 40, a filter 43, a tank 44 for storing the target substance 40, a heater 45, a temperature sensor 46, a piezoelectric element 47, and a pressure regulator 48.

The nozzle 42 corresponds to the nozzle shown in FIG. 1. The filter 43 is arranged upstream of the nozzle 42 and removes impurities contained in the target substance 40. The target substance 40 is, for example, tin (Sn). The nozzle 42, the heater 45, and the temperature sensor 46 are fixed to the tank 44. The piezoelectric element 47 is fixed to the nozzle 42.

The pressure regulator 48 is arranged at a pipe 49 between the inert gas supply unit 34 and the tank 44. An inert gas supplied from the inert gas supply unit 34 may be, for example, an Ar gas or an He gas.

The target substance 40 in the tank 44 is output as a jet 81 from the nozzle 42 owing to the pressure difference between the pressure of the inert gas supplied from the pressure regulator 48 and the pressure in the chamber 22. When vibration is applied to the nozzle 42 by the piezoelectric element 47, the jet 81 output from the nozzle 42 is separated into droplet forms to form a droplet 82 (hereinafter, referred to as the DL 82).

The chamber 22 includes a droplet detection device 50, a laser light concentrating optical system 54, a two-axis stage 55, and a target collection unit 56.

The droplet detection device 50 (hereinafter, referred to as the DL detection device 50) corresponds to the droplet detection sensor shown in FIG. 1. The DL detection device 50 includes a light source unit 61 and a light receiving unit 62. The light source unit 61 includes a CW laser 63 which is a light source, an illumination optical system 64 which is a light concentrating lens, and a window 65. The light source unit 61 is arranged so as to illuminate the DL 82 at a predetermined position P on a target trajectory between the nozzle 42 of the target supply unit 32 and a plasma generation region 80. The DL detection device 50 is an example of the “first sensor” in the present disclosure.

The light receiving unit 62 includes an optical sensor 66 which is a light receiving element, and a window 67 and a light receiving optical system 68 for introducing CW laser light to the optical sensor 66. The light receiving unit 62 is arranged so as to receive the CW laser light output from the light source unit 61. When the DL 82 blocks the CW laser light, the output of the optical sensor 66 varies. The light receiving unit 62 outputs a passage timing signal TS notifying the timing at which the DL 82 passes the position P based on the variation. The passage timing signal TS is input to the EUV light generation processor 24.

The EUV light generation processor 24 includes a control program 25 and a delay circuit 26. The passage timing signal TS is input to the delay circuit 26 via the EUV light generation processor 24. The EUV light generation processor 24 sets a delay time of the delay circuit 26. Here, the delay circuit 26 may be configured separately from the EUV light generation processor 24, and a signal line for setting the delay time of the delay circuit 26 from the EUV light generation processor 24 may be connected to the delay circuit 26.

The delay circuit 26 adds a delay time to the passage timing signal TS to generate a light emission trigger signal Tr. The light emission trigger signal Tr output from the delay circuit 26 is input to the pulse laser device 90.

The pulse laser device 90 outputs pulse laser light based on the light emission trigger signal Tr. The pulse laser device 90 may be, for example, a CO: laser device. Further, the pulse laser device 90 may be a solid-state laser device in which a crystal obtained by doping any one of YVO₄ (yttrium-vanadium oxide), YLF (yttrium-lithium fluoride), and YAG (yttrium-aluminum-garnet) with an impurity is used as a laser medium.

The laser light concentrating optical system 54 is an optical system that concentrates the pulse laser light output from the laser device 90 and introduced into the chamber 22 on the plasma generation region 80. The laser light concentrating optical system 54 is supported by the two-axis stage 55. The two-axis stage 55 can move the laser light concentrating optical system 54 in two axis directions of a first axis direction and a second axis direction. For example, the first axis direction may be the Z-axis direction, and the second axis direction may be the Y-axis direction.

By adjusting the position of the laser light concentrating optical system 54 by the two-axis stage 55, it is possible to adjust the concentration position of the pulse laser light into the plasma generation region 80. The laser light concentrating optical system 54 may include a plurality of optical elements.

The target collection unit 56 is arranged on the trajectory of the DL 82, and collects the DL 82 which has not been irradiated with the pulse laser light.

Further, an EUV light concentrating mirror (not shown) is arranged in the chamber 22. The EUV light concentrating mirror has a spheroidal reflection surface. A multilayer reflective film in which molybdenum and silicon are alternately laminated is formed on the reflection surface of the EUV light concentrating mirror. The EUV light concentrating mirror has a first focal point and a second focal point and is positioned such that the first focal point is located in the plasma generation region 80. The EUV light concentrating mirror selectively reflects EUV light from among the radiation light that is radiated from the plasma generated at the plasma generation region 80. The EUV light concentrating mirror concentrates the selectively reflected EUV light on the second focal point (intermediate focal point). An aperture (not shown) is arranged at the intermediate focal point, and the EUV light having passed through the aperture enters an exposure apparatus or an inspection apparatus (not shown).

### 2.2 Operation

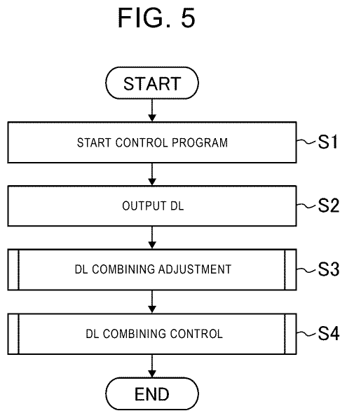

FIG. 5 is a flowchart showing main flow of operation of the EUV light generation apparatus 10. In step S1, the EUV light generation processor 24 executes the control program 25 when EUV light generation is commanded from an operator or an external apparatus (not shown). When the EUV light generation processor 24 starts executing the control program 25, the DL 82 is output from the target supply unit 32 in step S2.

In step S2, the EUV light generation processor 24 controls the heater power source 38 based on a detection value of the temperature sensor 46 so that the temperature of Sn in the target supply unit 32 becomes equal to or higher than the melting point and to melt Sn stored in the tank 44. For example, the EUV light generation processor 24 controls the heater power source 38 so that Sn in the target supply unit 32 becomes a predetermined temperature of 232° C. to 300° C. The EUV light generation processor 24 also controls the inert gas to a predetermined pressure by the pressure regulator 48, for example, the pressure of 0.2 MPa to 40 MPa, to output the liquid Sn inside the tank 44 to the outside of the nozzle 42.

The EUV light generation processor 24 vibrates the nozzle 42 so that the jet 81 of the liquid Sn output from the nozzle 42 is turned into droplets and a plurality of droplets are combined to generate a combined DL having a predetermined diameter at a predetermined cycle. For example, the EUV light generation processor 24 applies a voltage waveform of a rectangular wave having a predetermined frequency and a predetermined Duty to the piezoelectric element 47 via the piezoelectric power source 37, and causes the nozzle 42 to vibrate at a predetermined frequency. The piezoelectric element 47 is an example of a vibration element that applies vibration to the liquid target substance 40.

Hereinafter, the term “DL” in the case of generating a DL or generation of a DL in the present specification refers to a combined DL unless otherwise specified. In the present specification, the Duty of the voltage waveform of the rectangular wave applied to the piezoelectric element 47 is referred to as “Duty for the piezoelectric element 47”, “piezoelectric Duty”, or simply “Duty”. The Duty is one of vibration parameters related to the vibration of the piezoelectric element 47, and the value of the Duty is referred to as a “Duty value”.

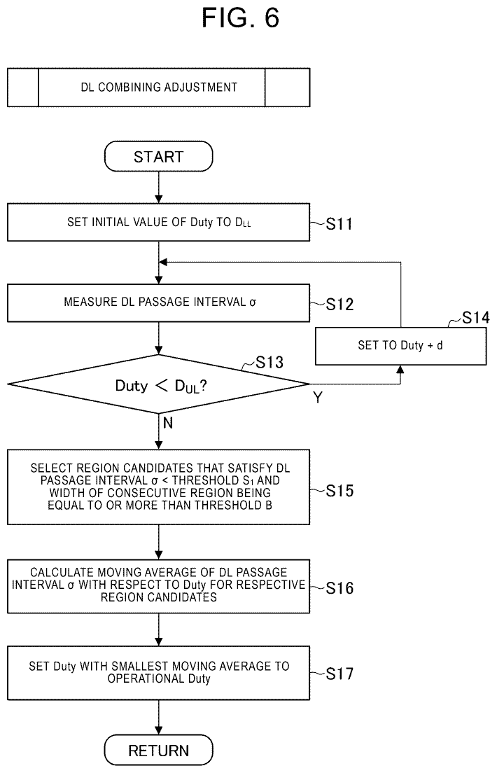

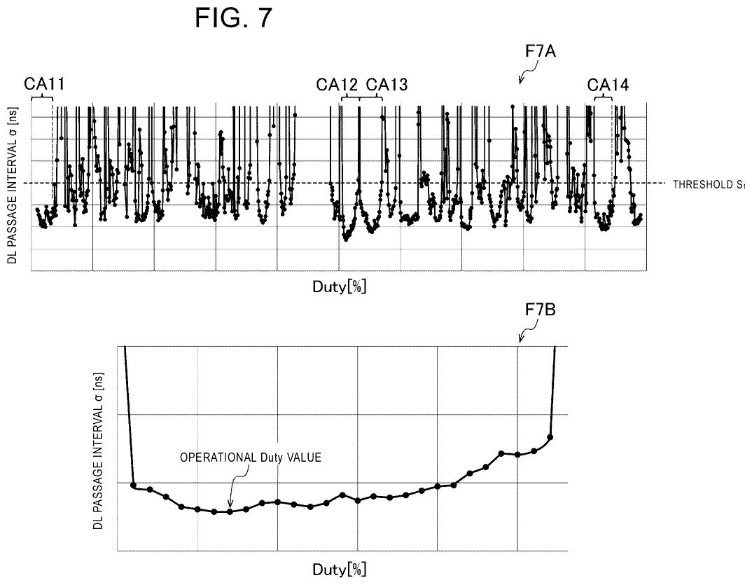

In step S3, the EUV light generation processor 24 performs processing of DL combining adjustment. The DL combining adjustment is the processing of adjusting into an appropriate Duty using the DL passage interval σ as an index. A specific example of the subroutine of the DL combining adjustment applied to step S3 will be described later with reference to FIGS. 6 and 7.

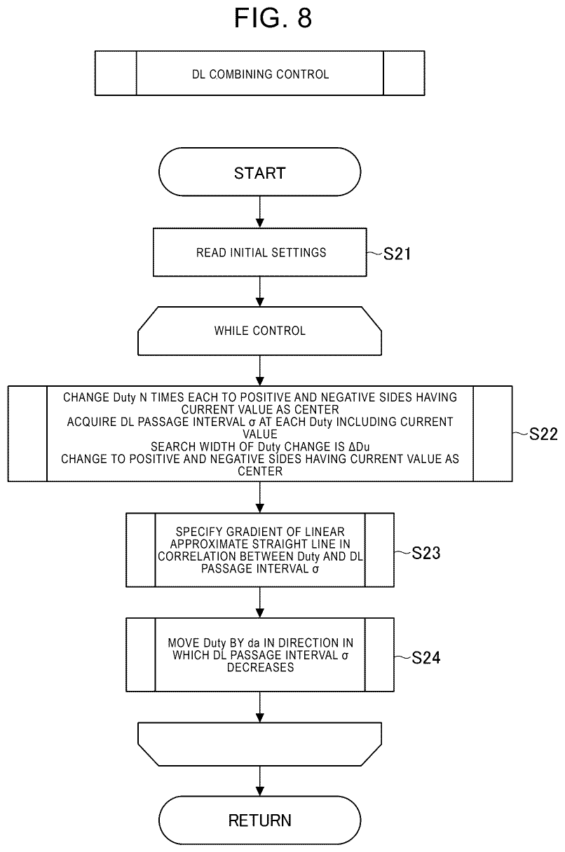

Thereafter, in step S4, the EUV light generation processor 24 starts the DL combining control to maintain a DL combining state by finely adjusting the Duty. Here, the DL combining control may be performed irrespective of non-irradiation (at the time of EUV non-emission) and irradiation (at the time of EUV emission) to the DL 82 with the pulse laser light. A specific example of the subroutine applied to the DL combining control in step S4 will be described later with reference to FIG. 8.

After step S4 is completed, the EUV light generation processor 24 ends the flowchart of FIG. 5.

### 2.2.1 Example of DL Combining Adjustment

FIG. 6 is a flowchart showing an example of the DL combining adjustment subroutine applied to step S3 in FIG. 5. The present subroutine is executed during DL output at the time of EUV non-emission.

When the process in step S3 is started, in step S11, the EUV light generation processor 24 reads initial parameters and sets the Duty of the piezoelectric element 47 to a lower limit value D_{LL} which is an initial value. In addition to the lower limit value D_{LL}, the initial parameters include an upper limit value D_{UL}, a step amount d, a number of calculation samples of the DL passage interval σ, a moving average number No of the DL passage interval σ, a threshold S₁ of the DL passage interval σ, and a threshold B of consecutive Duty width determination.

As typical values of the initial parameters, the lower limit value D_{LL} may be 1%, the upper limit value D_{UL} may be 99%, the step amount d may be 0.18, the number of calculation samples of the DL passage interval σ may be 10000, the moving average number Nσ of the DL passage interval σ may be 0.6%, and the threshold S₁ of the DL passage interval σ may be 170 ns. When step amount d is 0.1%, the moving average number Nσ of the DL passage interval σ being 0.6% means that the number of sections of the moving average is 0.6-0.1=6. Further, the threshold B of the consecutive Duty width determination may be set by determining a value with which the combining can be maintained for a long period of time by experiment or the like. The threshold B of the consecutive Duty width determination may be 0.6% or more and, for example, the threshold B may be 0.6%.

The EUV light generation processor 24 can change the Duty in units of the step amount d in a numerical range from the lower limit value D_{LL} to the upper limit value D_{UL}.

In step S12, the EUV light generation processor 24 measures the DL passage interval σ with the set Duty value. That is, the EUV light generation processor 24 controls the piezoelectric power source 37 so as to apply the voltage waveform of the rectangular wave having the set Duty value to the piezoelectric element 47, and drives the piezoelectric element 47 via the piezoelectric power source 37 to generate the DL 82. Further, the EUV light generation processor 24 acquires the passage timing signal TS from the light receiving unit 62, and calculates the DL passage interval σ based on the passage timing signal and Expression 1. The number of DLs for each Duty value, which is the number of calculation samples of the DL passage interval σ, may be, for example, 10000. Then, the EUV light generation processor 24 stores the Duty and the DL passage interval σ in association with each other in a memory.

In step S13, the EUV light generation processor 24 determines whether or not the set Duty value is smaller than the upper limit value D_{UL}. When the determination result in step S13 is Yes, the EUV light generation processor 24 proceeds to step S14, sets a new Duty value by adding the step amount d to the set Duty value, and then returns to step S12.

The loop of steps S12 to S14 is repeated until the Duty value reaches the upper limit value D_{UL}. Thus, by measuring the DL passage interval σ with each Duty value while increasing the Duty from the lower limit value D_{LL} to the upper limit value D_{UL} in increments of the step amount d, characteristic data (see FIG. 7) indicating the relationship between the Duty and the DL passage interval σ can be obtained.

When the Duty value reaches the upper limit value D_{UL} and the determination result in step S13 is No, the EUV light generation processor 24 proceeds to step S15. In step S15, the EUV light generation processor 24 selects region candidates that satisfy the condition that the DL passage interval σ is less than the threshold S₁ and that the width of the region (consecutive region) of the consecutive Duty is equal to or more than the threshold B.

In step S16, the EUV light generation processor 24 calculates the moving averages of the DL passage interval σ with respect to the Duty for the respective region candidates selected in step S15. Instead of the moving average, the EUV light generation processor 24 may perform a filter operation on the data sequence to smooth out protruding data.

In step S17, the EUV light generation processor 24 sets the Duty value with which the moving average calculated in step S16 is the minimum to the operational Duty value. After step S16, the EUV light generation processor 24 returns to the flowchart of FIG. 5.

FIG. 7 is a graph showing an example of the DL passage interval σ measured in the DL combining adjustment. In FIG. 7, the horizontal axis represents the Duty, and the vertical axis represents the DL passage interval σ. FIG. F7A at the upper stage of FIG. 7 shows an example of the DL passage interval σ obtained by scanning with the Duty value being from 1% to 99% in increments of 0.1% while the irradiation of the pulse laser light is stopped.

In FIG. F7A at the upper stage, four region candidates CA11, CA12, CA13, CA14 are regions satisfying the condition that the DL passage interval σ is less than the threshold S₁ and the width of the consecutive region is equal to or more than the threshold B of the consecutive Duty width determination. The region candidates CA11, CA12, CA13, CA14 are regions in the vicinity of the Duty values of 3%, 53%, 56%, and 93%, respectively.

Here, the moving average of the DL passage interval σ with the Duty is calculated for each of the four region candidates CA11, CA12, CA13, CA14, and the operational Duty value is set to the Duty value with which the moving average is the minimum. FIG. F7B at the lower stage of FIG. 7 is an enlarged graph of the region candidate CA12, and shows an example of the operational Duty value set from the moving averages.

### 2.2.2 Example of DL Combining Control

FIG. 8 is a flowchart showing an example of a DL combining control subroutine applied to step S4 in FIG. 5. In the DL combining control subroutine of FIG. 8, the Duty is controlled using the DL passage interval σ as an index. This subroutine can be performed at both the time of EUV non-light emission and the time of EUV light emission.

When the process of step S4 is started, in step S21, the EUV light generation processor 24 reads initial settings. The parameters for performing the initial setting include a search range ΔDu of the Duty value, a search level number N of the Duty, a Duty moving amount da, and the number of calculation samples Ns of the DL passage interval σ. The EUV light generation processor 24 reads the initial setting value for each of these parameters. For example, as the typical values of the parameters, the search width ΔDu may be 0.02%, the search level number N may preferably be 2 or more, for example, 5, the Duty moving amount da may be 0.02%, and the number of calculation samples of the DL passage interval σ may be 10000.

In step S22, the EUV light generation processor 24 drives the piezoelectric element 47 at respective N Duty values on the positive side and the negative side having the current value of the Duty as the center based on the initial setting read in step S21 to generate the DL. Further, the EUV light generation processor 24 acquires the DL passage interval σ for the generated DL and obtains a correlation between the Duty and the DL passage interval σ. The interval between the search level numbers N may be the search width ΔDu, and the order of the Duty value to be set at the time of the level change may be arbitrary. In addition, it is desirable that the range to be searched for by the search width ΔDu is set to a range in which a significant difference in DL combining performance is obtained.

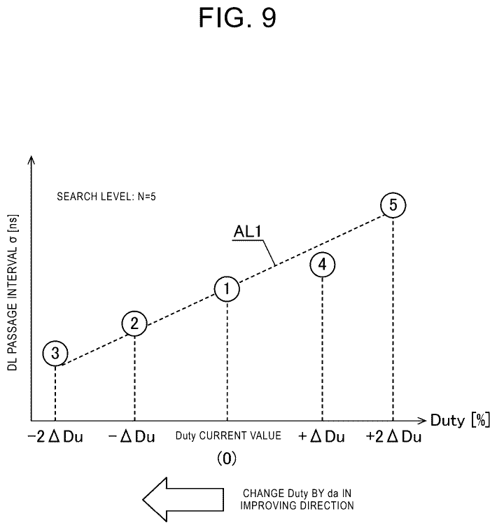

In step S23, the EUV light generation processor 24 calculates a linear approximate straight line with the Duty as the horizontal axis and the DL passage interval σ as the vertical axis in the correlation between the Duty and the DL passage interval σ acquired in step S22, and specifies the gradient thereof (see FIG. 9).

In step S24, the EUV light generation processor 24 changes the Duty in the performance improving direction, that is, in the direction in which the DL passage interval σ decreases, based on the gradient of the approximate straight line specified in step S23. For example, when the gradient is positive, the EUV light generation processor 24 changes the Duty from the current value (0 position) in the negative direction. Further, when the gradient is negative, the EUV light generation processor 24 changes the Duty from the current value in the positive direction. The change amount of the Duty at this time may be set to a Duty value that differs from the current value by the moving amount d, or any Duty value that is in the performance improving direction. The change amount in the Duty may be different depending on the value of the gradient. Thereafter, the piezoelectric element 47 is driven with the Duty value having the smaller DL passage interval σ.

Here, when the absolute value of the gradient can be regarded as 0, the EUV light generation processor 24 may not change the Duty.

After step S24, the EUV light generation processor 24 returns to step S22 and repeats the same processes (steps S22 to S24) using the changed Duty as the current value.

The processes of steps S22 to S24 are for maintaining the DL combining state by finely adjusting the Duty value using the DL passage interval σ as an index, and are performed repeatedly as long as the combining state of the DL needs to be maintained. When there is no need to maintain the DL combining state in association with the stop of DL outputting by the stop command or the like from an operator or an external apparatus (not shown), the EUV light generation processor 24 ends the repetitive processes and ends the present subroutine.

FIG. 9 is a graph for explaining the process of changing the Duty in the performance improving direction. In FIG. 9, the horizontal axis represents the Duty, and the vertical axis represents the DL passage interval σ. Each circle in FIG. 9 represents a plot position of the DL passage interval σ with respect to the Duty, and a number in the circle represents a search order. In the example shown in FIG. 9, the Duty values of the search orders 1, 2, 3, 4, and 5 are “current value”, “current value−ΔDu”, “current value−ΔDu×2”, “current value+ΔDu”, and “current value+ΔDu×2”, respectively. From these five plot points, an approximate straight line AL1 indicated by a broken line in FIG. 9 can be obtained by linear approximation.

In the example of FIG. 9, a gradient G of the approximate straight line AL1 is larger than 0, and the direction in which the Duty is decreased with respect to the current value is the direction in which the value of the DL passage distance σ is improved. Therefore, in this case, as the process of step S24, the Duty value is changed from the current value in the negative direction by the moving amount da.

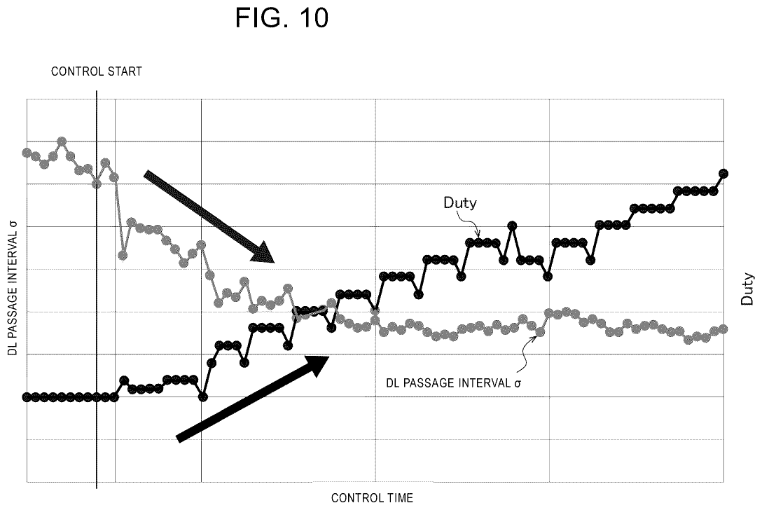

FIG. 10 is a graph showing an example of change in the DL passage interval σ and the Duty with respect to the control time in the DL combining control. In this example, the DL passage interval σ is improved by being controlled so as to increase the Duty value in a broad sense.

### 2.3 Problem

The Duty adjustment in the comparative example is performed based on an index based on “time” using the DL detection device 50. Therefore, when the DL performance is deteriorated based on the “space” derived from the Duty that cannot be detected by the DL detection device 50, the Duty cannot be adjusted.

For example, as the DL performance deterioration based on “space” that cannot be detected by the DL detection device 50, there is a phenomenon in which a DL position shift in the horizontal direction (so-called “lateral shift”) occurs in a particular piezoelectric Duty.

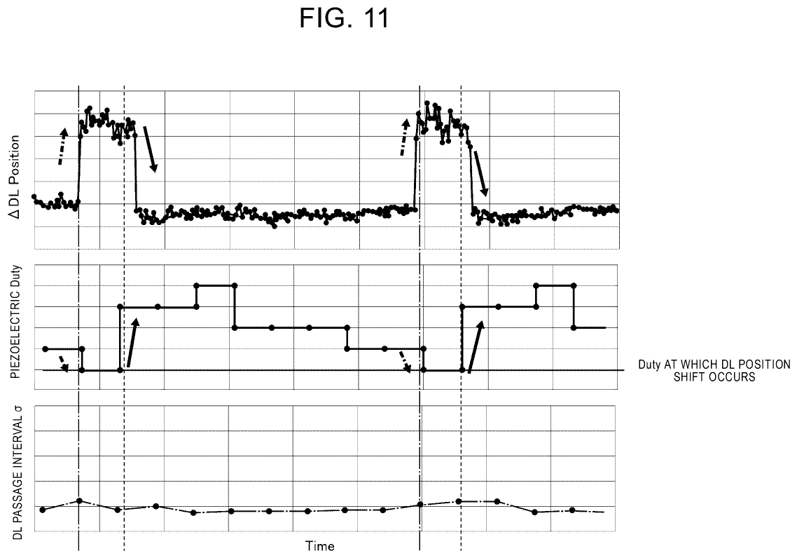

FIG. 11 is a graph showing an example of the DL position shift derived from the piezoelectric Duty. In FIG. 11, the middle stage shows the setting values of the piezoelectric Duty, the upper stage shows the DL position deviation, and the lower stage shows the DL passage interval σ. The DL position deviation means a shift amount (DL position shift) from a DL target position. The horizontal axis of each graph is time and the time axis is common.

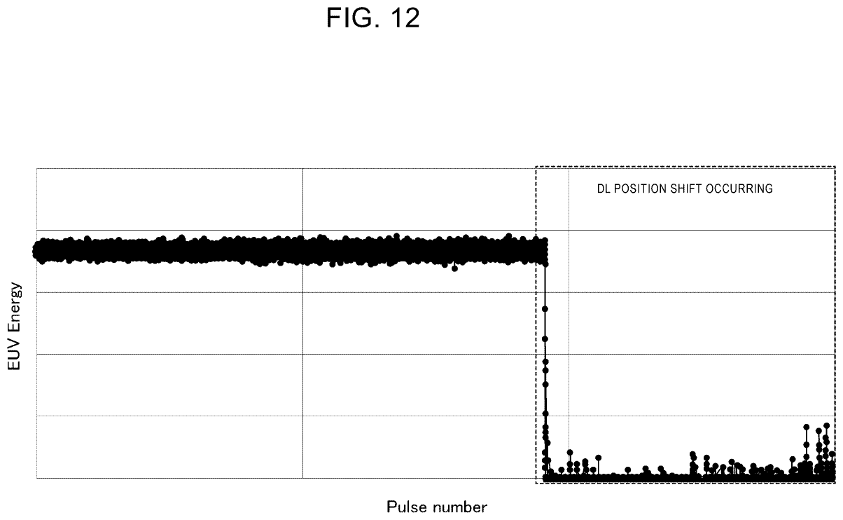

As shown in FIG. 11, when a particular piezoelectric Duty is used, the relative position shift occurs between the DL and the irradiation position of the laser light, leading to deterioration in EUV energy stability (see FIG. 12) and fragment generation.

FIG. 12 is a graph showing the EUV performance (here, the EUV energy) when the DL position shift occurs.

When the EUV collector mirror is contaminated due to fragment generation, maintenance is required, and there is a fear of a decrease in the operation hours of the device and an increase in cost due to a high maintenance frequency.

Therefore, there has been a demand for an EUV light generation apparatus capable of performing the Duty adjustment with suppressed DL position shift.

2.4 Mechanism by which DL Position Shift Occurs (Mechanism of Problem)

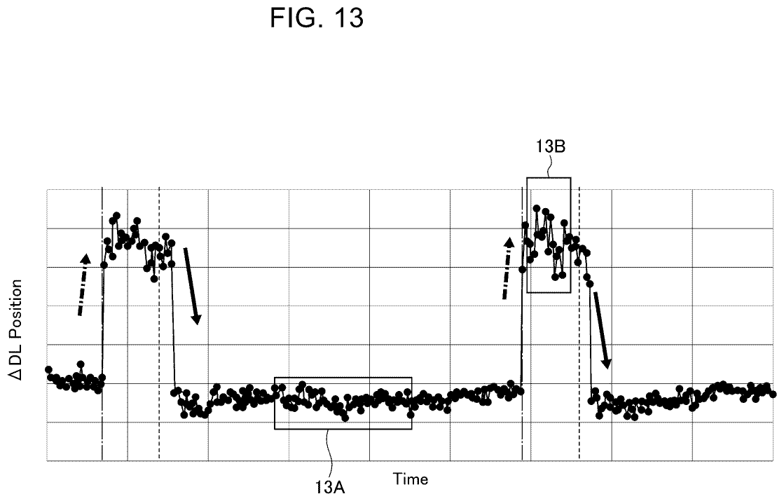

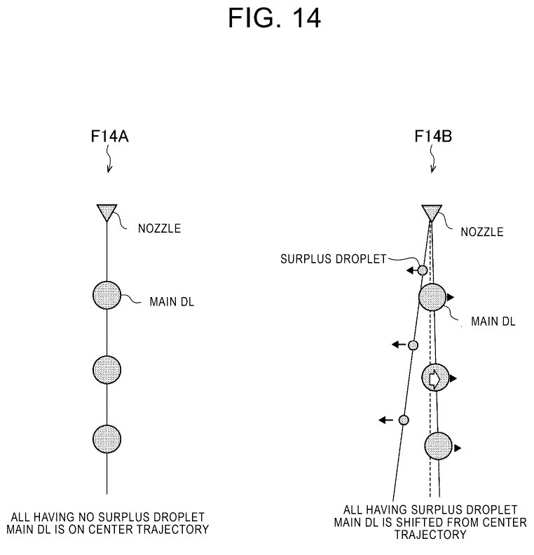

Referring to FIGS. 13 and 14, the mechanism of DL position shift derived from the piezoelectric Duty will be described. FIG. 13 is a graph showing the DL position shift derived from the piezoelectric Duty.

FIG. 14 is a schematic diagram of DL generation operation corresponding to a portion surrounded by each of surrounding frame lines 13A, 13B in FIG. 13. FIG. F14A on the left side of FIG. 14 shows the DL generation operation corresponding to the portion surrounded by the surrounding frame line 13A in FIG. 13, and FIG. F14B on the right side thereof shows the DL generation operation corresponding to the portion surrounded by the surrounding frame line 13B in FIG. 13.

As shown in FIG. F14A on the left side of FIG. 14, when the DL generation operation is normal, the main DL (laser-irradiated DL) output from the nozzle 42 travels on a predetermined trajectory (hereinafter, referred to as a DL trajectory) as combining the motion components of uncombined fine droplets.

Therefore, as shown in FIG. F14B on the right side, when there is an uncombined fine droplet (surplus droplet), the horizontal motion component of the surplus droplet is removed due to the principle of momentum conservation, so that the main DL is given the opposite horizontal motion component, and it is considered that deviation occurs from the DL trajectory with no surplus droplet.

### 3. First Embodiment

### 3.1 Configuration

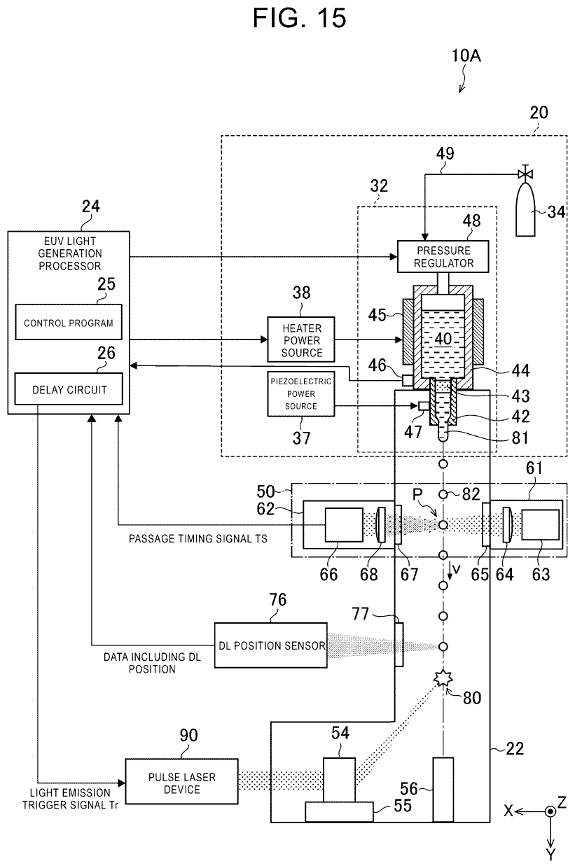

FIG. 15 schematically shows the configuration of an EUV light generation apparatus 10A according to a first embodiment. The configuration shown in FIG. 15 will be described in terms of differences from the configuration of the EUV light generation apparatus 10 shown in FIG. 4.

The EUV light generation apparatus 10A includes a droplet position sensor (DL position sensor) 76. The DL position sensor 76 is arranged at a position for observing the DL trajectory between the target supply unit 32 and the plasma generation region 80. The DL position sensor 76 includes an image sensor such as a CCD camera. The DL position sensor 76 is an example of the “second sensor” in the present disclosure.

The EUV light generation apparatus 10A may include a light source (not shown) for illuminating the DL 82 in the field of view of the DL position sensor 76. The chamber 22 includes a window 77, and the DL position sensor 76 may image the DL 82 in the field of view through the window 77. The DL position sensor 76 is connected to the EUV light generation processor 24. Other configurations may be similar to those of the EUV light generation apparatus 10 shown in FIG. 4. The field of view of the DL position sensor 76 is an example of the “passage position of the droplet” in the present disclosure.

### 3.2 Operation

The operation of the EUV light generation apparatus 10A will be described. The DL position sensor 76 images the DL 82 and acquires image data. The image data acquired by the DL position sensor 76 is transmitted to the EUV light generation processor 24.

The EUV light generation processor 24 calculates the DL position from the acquired image.

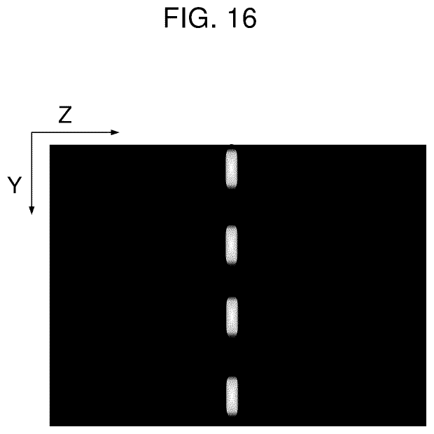

FIG. 16 is an example of the image for detecting the droplet position as the image data acquired via the DL position sensor 76. For example, the DL 82 is imaged while the DL position sensor 76 is arranged to observe the DL trajectory from the positive side in the X-axis direction, and the Z-direction position of the DL 82 is specified by associating the image with the coordinates.

Further, a DL position sensor (not shown) may be arranged to observe the DL trajectory from the positive side in the Z-axis direction, and the X-direction position of the DL 82 may be acquired.

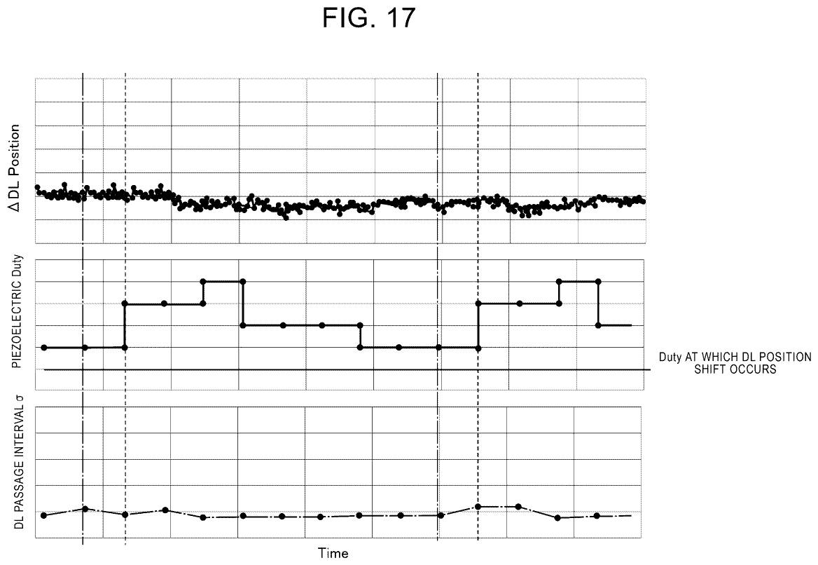

FIG. 17 shows an example of piezoelectric Duty operation in the EUV generation apparatus 10A. The EUV light generation apparatus 10A stores a piezoelectric Duty with which the DL position shift occurs at the time of the DL combining adjustment. Then, the EUV light generation processor 24 does not set the piezoelectric Duty with which the DL position shift occurs in the Duty adjustment operation such as the DL combining control. That is, the EUV light generation processor 24 provides a prohibited Duty region (prohibited band) prohibiting setting of the piezoelectric Duty. The prohibited band may be a consecutive Duty region or a set of discrete Duty regions. The prohibited Duty region is an example of the “prohibited duty” in the present disclosure.

The Duty indicated by a thick line in the graph shown in the middle stage of FIG. 17 is the Duty with which the DL position shift occurs.

The EUV light generation processor 24 sets the piezoelectric Duty while avoiding the prohibited band with which the DL position shift occurs. As a result, as is apparent from comparison with FIG. 11, the DL position shift is suppressed.

The main flow of the operation of the EUV light generation apparatus 10A is similar to that of FIG. 5, but differs from the operation of the comparative example in that not only the DL passage interval σ is used as an index in the DL combining adjustment of step S3 but also the DL position is used as an index.

That is, the operation of the EUV light generation apparatus 10A differs from the operation of the EUV light generation apparatus 10 of the comparative example in the DL combining adjustment subroutine and the DL combining control subroutine.

### 3.2.1 Example of DL Combining Adjustment

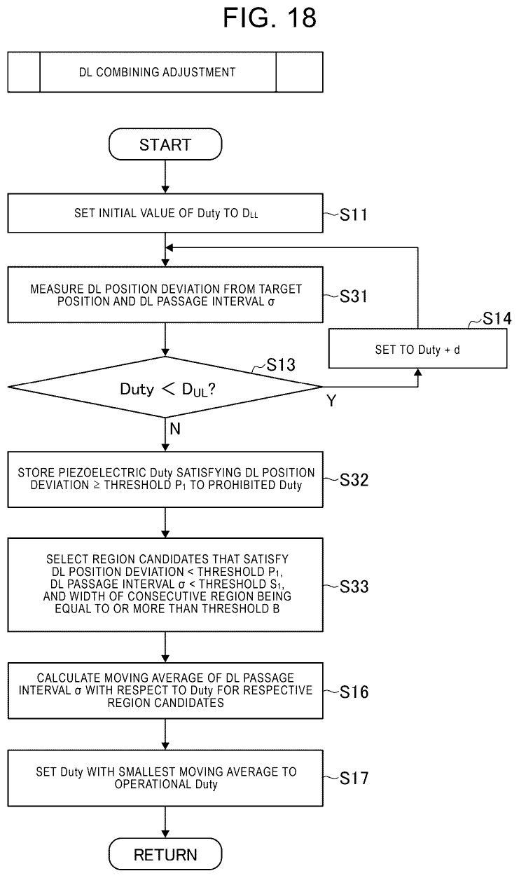

FIG. 18 is a flowchart showing an example of the DL combining adjustment subroutine according to the first embodiment. FIG. 18 will be described in terms of differences from FIG. 6.

In the flowchart shown in FIG. 18, step S31 is included instead of step S12 of FIG. 6, and steps S32 and S33 are included instead of step S15.

In the subroutine of the DL combining adjustment of FIG. 18, the Duty is adjusted using the DL passage interval σ and the DL position as indices. Thus, the initial parameters read in step S11 of FIG. 18 include, in addition to those described with reference to FIG. 6, a DL target position, a number of calculation samples of the DL position, and a threshold P₁ of the DL position deviation. As typical values of the initial parameters, for example, the DL target position is 0 μm, the number of calculation samples of the DL position is 5, and the threshold P₁ is 2 μm.

At step S31 after step S11, the EUV light generation processor 24 measures the DL position deviation from the target position and the DL passage interval σ at the set Duty value. That is, the EUV light generation processor 24 controls the piezoelectric power source 37 to apply the voltage waveform of the rectangular wave having the set Duty value to the piezoelectric element 47, so that the DL 82 is generated, and measures the DL position deviation from the image data obtained from the DL position sensor 76. The EUV light generation processor 24 measures the DL passage interval σ in a similar manner as in step S15. Then, the EUV light generation processor 24 stores the Duty, the DL position deviation, and the DL passage interval σ as being associated with one another.

When a plurality of the DL position sensors 76 are arranged, the DL position deviations from the target positions of the detection positions in the respective DL position sensors are stored. Here, the EUV light generation processor 24 measures the DL passage interval σ with the conditions other than the Duty being constant. After step S31, processing proceeds to step S13.

The processes of S31, S13, S14 are repeated until the Duty value reaches the upper limit value D_{UL}. Thus, by measuring the DL position deviation and the DL passage interval σ with each Duty value while increasing the Duty from the lower limit value D_{LL} to the upper limit value D_{UL} in increments of the step amount d, characteristic data indicating the relationship among the Duty, the DL position deviation, and the DL passage interval σ can be obtained.

When the determination result in step S13 is No, the EUV light generation processor 24 proceeds to step S32.

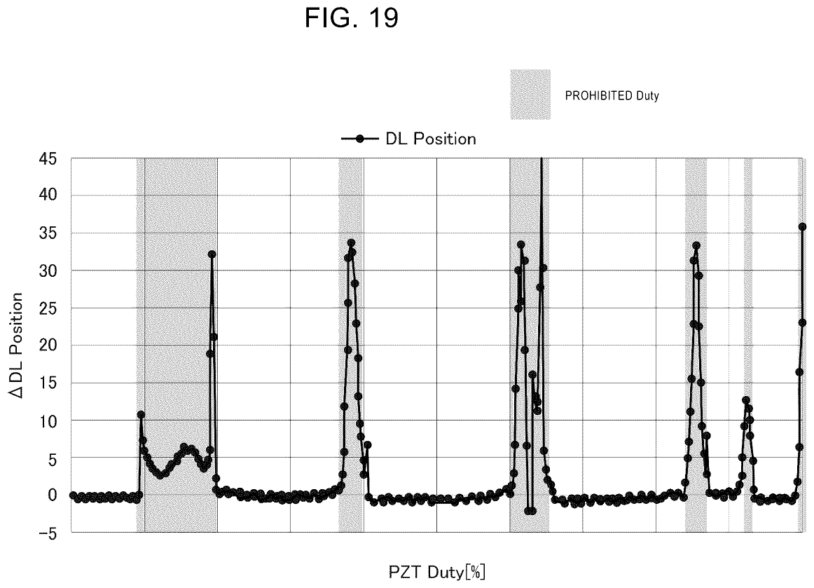

In step S32, the EUV light generation processor 24 stores the piezoelectric Duty with which the DL position deviation is equal to or more than the threshold P₁ as the prohibited Duty based on the characteristic data acquired in step S31 (see FIG. 19). When the plurality of DL position sensors are arranged, the prohibited Duty is set if the DL position deviation of any of the sensors is equal to or more than the threshold P₁. Further, the prohibited Duty stored in step S32 may be updated every predetermined period of time or for every DL combining adjustment. Being equal to or more than the threshold P₁ is an example of being “equal to or more than a first threshold” in the present disclosure.

In step S33, the EUV light generation processor 24 selects region candidates that satisfy a condition that the DL position deviation is less than the threshold P₁, the DL passage interval σ is less than the threshold S₁, and the width (continuous Duty width) of the region (continuous region) of the continuous Duty is equal to or more than the threshold B of the consecutive Duty width determination. Such a condition is an example of the “predetermined condition” in the present disclosure.

After step S33, the EUV light generation processor 24 proceeds to step S16.

Other steps may be similar to those in FIG. 6.

FIG. 19 is a graph showing an example of the prohibited Duty that is set based on the data indicating the relationship between the piezoelectric Duty and the DL position deviation. In FIG. 19, regions of the Duty indicated by the fill pattern are prohibited bands, and the Duty belonging to any prohibited band is the prohibited Duty that cannot be set. In FIG. 19, the Duty with which the DL position deviation is 2 μm being the threshold P₁ or more is stored as the prohibited Duty.

### 3.2.2 Example of DL Combining Control

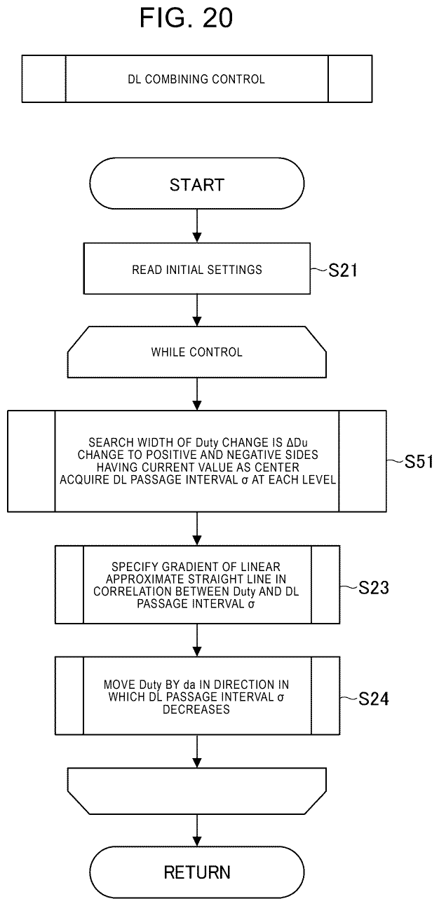

FIG. 20 is a flowchart showing an example of the DL combining control subroutine applied to step S4 in FIG. 5. FIG. 20 will be described in terms of differences from FIG. 8.

In step S21 of FIG. 20, in addition to the parameters described in step S21 of FIG. 8, the EUV light generation processor 24 reads the information of the prohibited Duty with which the DL position deviation acquired in the DL combining adjustment (FIG. 18) is equal to or more than the threshold P₁.

The flowchart shown in FIG. 20 includes step S51 instead of step S22 of FIG. 8.

In step S51 after step S21, the EUV light generation processor 24 changes the Duty with the search width ΔDu to each of the positive side and the negative side having the current value of the Duty as the center, and acquires the DL passage interval σ at each level (see FIG. 9). However, in step S51, when the Duty after the change by the search width ΔDu corresponds to the prohibited Duty or crosses the prohibited Duty, the EUV light generation processor 24 does not set the Duty value to the positive side (or the negative side) from the Duty value of the level before the change.

Further, in step S24, when the Duty after the change by da corresponds to the prohibited Duty or crosses the prohibited Duty, the piezoelectric Duty is prohibited to be set thereto. Other operation may be similar to those in the flowchart of FIG. 8. The approximate straight line AL1 (FIG. 9) in step S23 of FIG. 20 is an example of the “first approximate straight line” in the present disclosure.

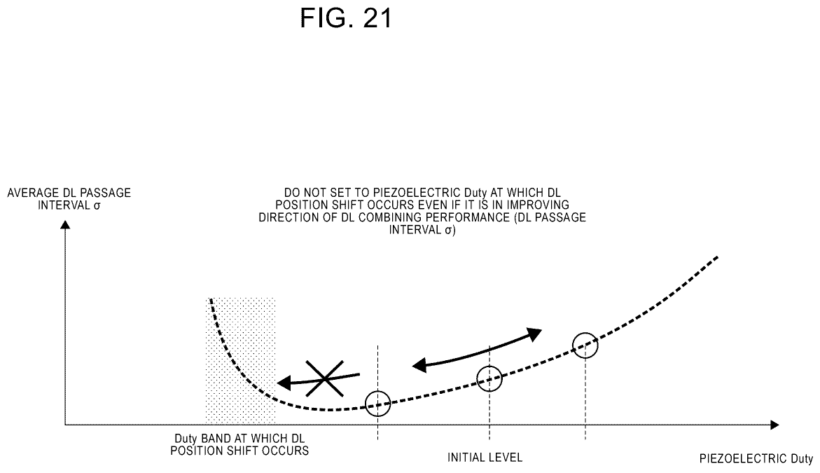

FIG. 21 is a conceptual diagram of operation in which setting to a piezoelectric Duty that corresponds to the prohibited Duty or crosses the prohibited Duty is prohibited. In FIG. 21, the horizontal axis represents the piezoelectric Duty, and the vertical axis represents the average DL passage interval σ. In the operation of the DL combining control, the DL passage interval σ is measured when the piezoelectric Duty is changed, for example, by changing the piezoelectric Duty in units of the search width ΔDu from the initial level. However, as shown in FIG. 21, even when the DL combining performance is to be improved, the EUV light generation processor 24 does not set the piezoelectric Duty to the prohibited Duty with which the DL position shift occurs, or to the piezoelectric Duty that crosses the prohibited Duty.

The droplet generation control method in the first embodiment is an example of the “droplet generation control method” in the present disclosure.

### 3.3 Effect

According to the EUV light generation apparatus 10A of the first embodiment, setting to the piezoelectric Duty with which the DL position shift occurs is prevented, so that the DL positional shift derived from the piezoelectric Duty is prevented. Therefore, the relative irradiation position between the DL 82 and the laser light is stabilized, and the EUV energy stability is improved. Further, fragment generation caused by the relative position shift between the DL 82 and the laser light is suppressed, and contamination on the EUV collector mirror is suppressed.

### 3.4 Modification

### 3.4.1 Configuration

The configuration of the EUV light generation apparatus according to a modification of the first embodiment may be similar to that of the EUV light generation apparatus 10A shown in FIG. 15.

### 3.4.2 Operation

In the EUV light generation apparatus according to the modification of the first embodiment, the DL position (μm) is also evaluated in the DL combining control in step S4 of FIG. 5. The operation of the modification of the first embodiment differs from the operation of the first embodiment in that, when the piezoelectric Duty satisfying a condition that the DL position deviation is equal to or more than the threshold P₁ is found during the operation of the DL combining control, the Duty satisfying this condition is added to the prohibited Duty and the data of the prohibited Duty is updated. Other operation may be similar to those in the first embodiment.

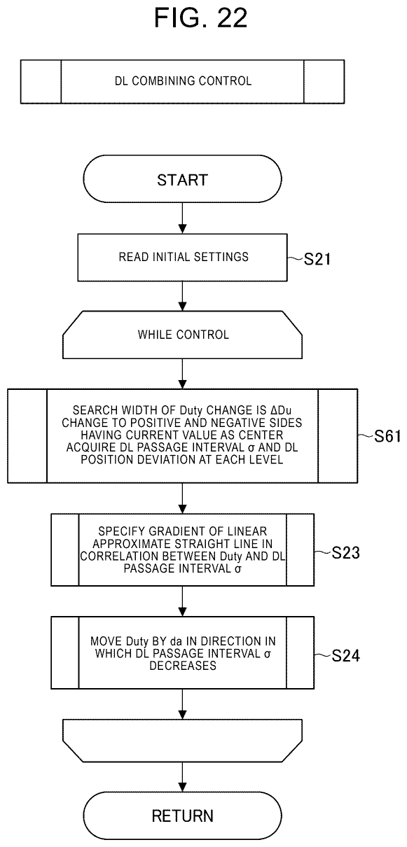

FIG. 22 is a flowchart showing an example of the DL combining control subroutine according to the modification of the first embodiment. The flowchart shown in FIG. 22 will be described in terms of differences from that shown in FIG. 20.

In step S21 of FIG. 22, in addition to the initial settings described in step S21 of FIG. 20, the EUV light generation processor 24 reads the initial setting of the DL target position, the number of DL position calculation samples, and the threshold P₁ of the DL position deviation. Typical values of these initial parameters are similar to those described in step S21 of FIG. 8.

In FIG. 22, step S61 is included instead of step S51 of FIG. 20. In step S61, the EUV light generation processor 24 changes the Duty with the search width ΔDu to each of the positive side and the negative side having the current value of the Duty as the center, and acquires the DL passage interval σ and the DL position deviation at each level.

When the DL position deviation is equal to or more than the threshold P₁, the EUV light generation processor 24 stores the current piezoelectric Duty and adds it to the prohibited Duty. Then, when the Duty after the change by the search width ΔDu corresponds to the prohibited Duty or crosses the prohibited Duty, the EUV light generation processor 24 does not set the piezoelectric Duty further to the positive side or the negative side. Other operation may be similar to those in the flowchart of FIG. 20.

### 3.4.3 Effect

According to the modification of the first embodiment, even when the DL position shift occurs with the piezoelectric Duty with which the DL position deviation has been less than the threshold P₁ in the DL combining control, setting to the piezoelectric Duty with which the DL positional shift occurs due to change over time or the like is prevented in the subsequent DL combining control operation. Accordingly, the EUV energy stability can be further improved.

### 4. Second Embodiment

### 4.1 Configuration

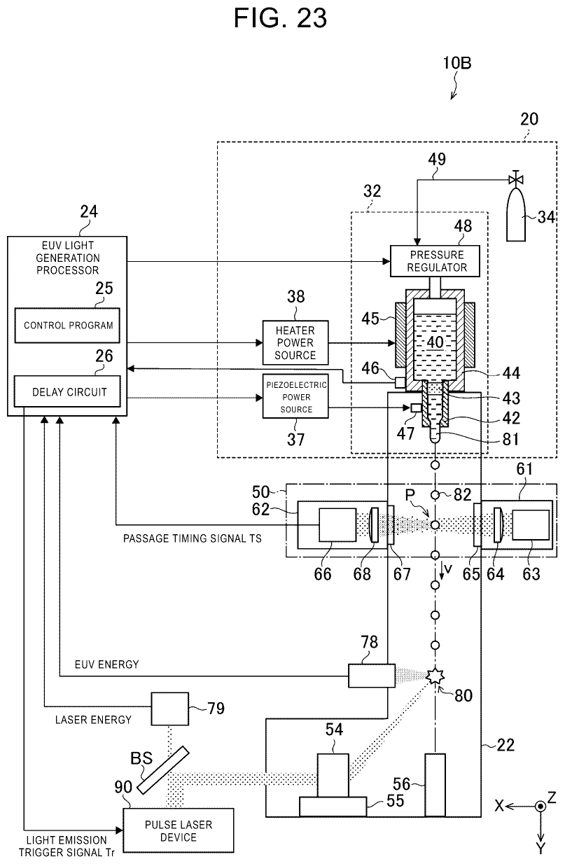

FIG. 23 schematically shows a configuration example of an EUV light generation apparatus 10B according to a second embodiment. The configuration shown in FIG. 23 will be described in terms of differences from the configuration of the EUV light generation apparatus 10A shown in FIG. 15. The EUV light generation apparatus 10B includes an EUV energy sensor 78 instead of the DL position sensor 76. The EUV energy sensor 78 is arranged at a position from which the plasma generation region 80 can be observed, and measures the EUV energy and transmits it to the EUV light generation processor 24.

Further, the EUV light generation apparatus 10B includes a beam splitter BS and a laser energy sensor 79.

The beam splitter BS is arranged on the optical path of the laser light between the pulse laser device 90 and the laser light concentrating optical system 54. The beam splitter BS is configured to transmit a part of the incident laser light and reflect another part thereof.

The laser energy sensor 79 is arranged at a position where it receives light having passed through or reflected by the beam splitter BS. Here, the laser energy sensor 79 exemplified in FIG. 23 is arranged at a position where it receives light having passed through the beam splitter BS. An optical system (not shown) may be arranged between the beam splitter BS and the laser energy sensor 79. The optical system may be a collimating optical system or a light concentrating optical system. The laser energy sensor 79 measures the laser energy laser, and transmits it to the EUV light generation processor 24. Other configurations may be similar to those of the EUV light generation apparatus 10A.

### 4.2 Operation

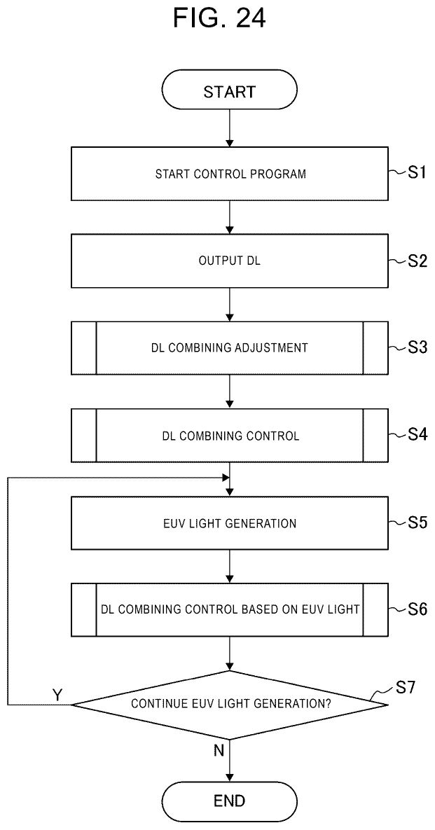

FIG. 24 is a flowchart showing main flow of operation of the EUV light generation apparatus 10B. The flowchart shown in FIG. 24 will be described in terms of differences from that shown in FIG. 5.

In FIG. 24, steps S5 to S7 are provided after the DL combining control (step S4). That is, in the EUV light generation apparatus 10B, the DL combining control (step S4) is performed before the EUV light emission, and the Duty is finely adjusted with high accuracy. The DL combining adjustment (step S3) and the DL combining control (step S4) may be similar to those in the first embodiment or the modification of the first embodiment.

Maintaining the DL combining state after step S4 is performed in the DL combining control (step S6) based on the EUV light.

In step S5, the EUV light generation processor 24 generates the EUV light.

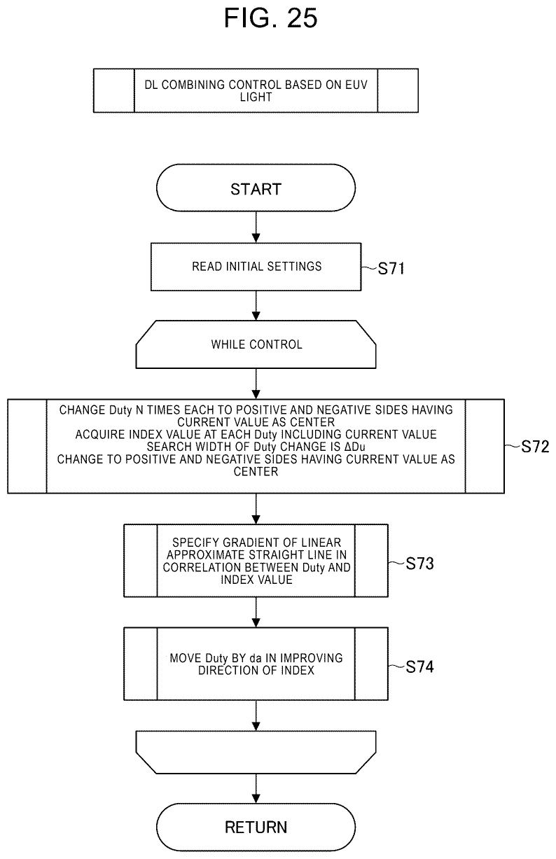

In step S6, the EUV light generation processor 24 performs the DL combining control based on the EUV light. A specific example of the process applied to step S6 will be described later with reference to FIGS. 25 to 29. The DL combining state is controlled by controlling the Duty of the piezoelectric element 47 using, as an index, a CE (Conversion Efficiency) which is an index value of the EUV performance during the EUV light generation. The CE is an example of the “ratio of EUV energy and laser energy” in the present disclosure.

The CE is the conversion efficiency of the EUV energy with respect to the laser energy and is calculated by the following expression.

CE=(EUV energy/laser energy)×100(%)

The index value (CE index value) based on the CE is, for example, an abnormal value occurrence rate of a CE difference. As other CE index values, a standard deviation of the CE difference and an outside-normal-range data occurrence rate (abnormal value occurrence rate) (%) are also useful.

When the piezoelectric Duty satisfying a condition that the CE index value is equal to or more than the threshold E₁ is found during the operation of the DL combining control (step S6) based on the EUV light, the piezoelectric Duty is added to the prohibited Duty and the setting of the prohibited Duty is updated. The stored piezoelectric Duty may be updated after a predetermined period of time. The threshold E or more is an example of being “equal to or more than a second threshold” in the present disclosure.

In step S7, the EUV light generation processor 24 determines whether or not to continue the EUV light generation. When the determination result of step S7 is Yes, processing returns to step S5. When the determination result in step S7 is No, the EUV light generation processor 24 ends the flowchart of FIG. 24.

FIG. 25 is a flowchart showing an example of the DL combining control subroutine based on the EUV light applied to step S6. The DL combining control based on the EUV light shown in FIG. 25 is performed at the time of the EUV light emission.

In step S71, the EUV light generation processor 24 reads initial settings. For example, as the parameters for performing the initial setting, the search range ΔDu may be 0.02(%), the search level number N may be 5, the Duty moving amount da may be 0.02(%), a number of samples of the index value may be 20000, and the threshold E₁ of the index may be 0.05.

The processes of steps S72 to S74 are processes to be repeated. In step S72, the EUV light generation processor 24 changes the Duty N times on each of the positive side and the negative side having the current value of the Duty as the center based on the read initial setting, and acquires the index value (CE index value) based on the CE in each of the Duties including the current value. The interval between the N levels may be the search width ΔDu, and the order of the Duty to be set at the time of the level change is arbitrary. Here, the search level number N is equal to or more than 2, for example, 5. Further, it is desirable the range of the search width Δdu is set to a width such that a significant difference is obtained in the index value based on the CE.

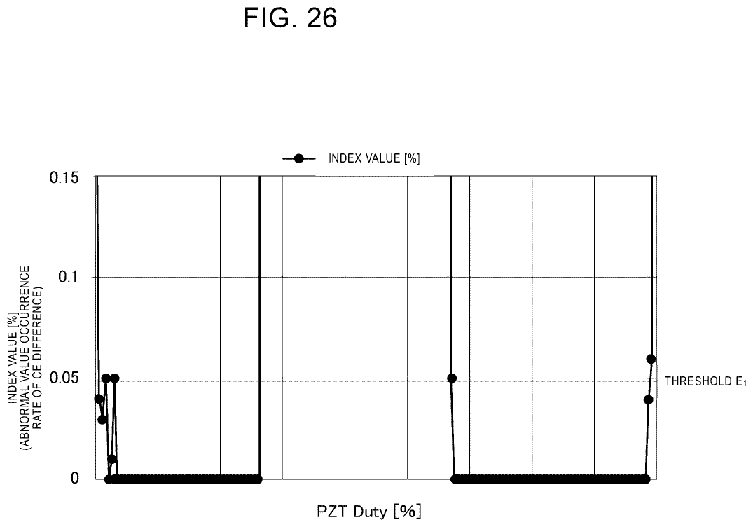

When the index value exceeds the threshold E₁, the EUV light generation processor 24 stores the current piezoelectric Duty (see FIG. 26). When the Duty after the change at the time of level change corresponds to the prohibited Duty (piezoelectric Duty having the index value equal to or more than E₁) or crosses the prohibited Duty, the EUV light generation processor 24 does not set the piezoelectric Duty to the positive side or the negative side.

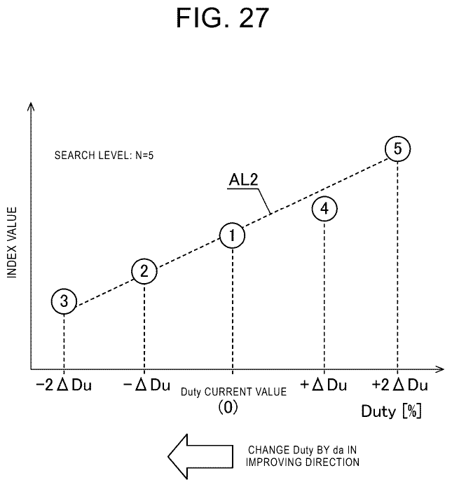

In step S73, the EUV light generation processor 24 calculates a linear approximate straight line in the correlation between the Duty acquired in step S72 and the index value based on the CE, and specifies the gradient thereof (see FIG. 27).

In step S74, the EUV light generation processor 24 changes the Duty in the improving direction of the index value (performance) based on the gradient of the linear approximate straight line created in step S73. For example, when the gradient is positive, the Duty is changed from the current value (0 position) in the negative direction. The change of the Duty at this time may be set with the moving amount da or set to any Duty in the improving direction. The change amount of the Duty may be varied depending on the value of the gradient.

After step S74, the EUV light generation processor 24 returns to step S72 and repeats the similar processing as having the changed Duty as the current value.

When the repetition termination condition of steps S72 to S74 is satisfied, the EUV light generation processor 24 ends the flowchart of FIG. 25 and returns to the flowchart of FIG. 24.

FIG. 26 is a graph showing the relationship between the Duty acquired in step S73 and the index value based on the CE. The horizontal axis represents the Duty, and the vertical axis represents the index value. Here, the index value is the abnormal value occurrence rate of the CE difference. When the index value is 0%, it indicates that the DL combining is in a good condition. As shown in FIG. 26, the Duty with which the index value exceeds the threshold E₁ is stored as the prohibited Duty that cannot be set.

FIG. 27 is a graph for explaining the process of changing the Duty in the improving direction of the index value. In FIG. 27, the horizontal axis represents the Duty, and the vertical axis represents the index value based on the CE. The description of FIG. 27 is similar to that of FIG. 9, where the circle in FIG. 27 represents the plot position of the index value with respect to the Duty, and the number in the circle represents the search order. From these five plot points, an approximate straight line AL2 indicated by a broken line in FIG. 27 can be obtained by linear approximation. The approximate straight line AL2 is an example of the “second approximate straight line” in the present disclosure.

In the example of FIG. 27, the gradient of the approximate straight line AL2 is positive, and the direction in which the Duty is decreased with respect to the current value is the direction in which the value of the index is improved. Therefore, in this case, as the process of step S74, the Duty value is changed from the current value in the negative direction by the moving amount da.

### 4.3 Example of Index Value Based on CE

The index to be used for the evaluation of the CE may be, for example, 3σ of the CE, 3σ of the CE difference, the abnormal value occurrence rate of the CE, or the abnormal value occurrence rate of the CE difference, as the index for evaluating variation of the CE. Here, “σ” represents a standard deviation.

The CE difference is a difference in the CE between two consecutive pulses, and a CE difference dCE(k) is defined by the following expression, where k is an integer representing a pulse number.

$$d C E ( k ) = C E ( k ) - CE ( k - 1 )$$

where CE(k) represents the CE of a pulse number k.

The abnormal value occurrence rate of the CE or the CE difference refers to a data occurrence rate outside the allowable range (normal range), and can be defined as a percentage of a value obtained by dividing the number of events in which the CE or the CE difference is distributed outside the allowable range by the number of samples n. The number of samples n for obtaining the index value may be, for example, 20000 pulses.

In the EUV light generation apparatus 10B according to the second embodiment, the Duty of the piezoelectric element 47 is controlled based on the evaluation value (index value) of the CE calculated based on the output of the EUV energy sensor 78 and the output of the laser energy sensor 79. Evaluating the variation of the CE corresponds to evaluating the stability of the energy of the generated EUV light, that is, evaluating the performance of EUV light generation.

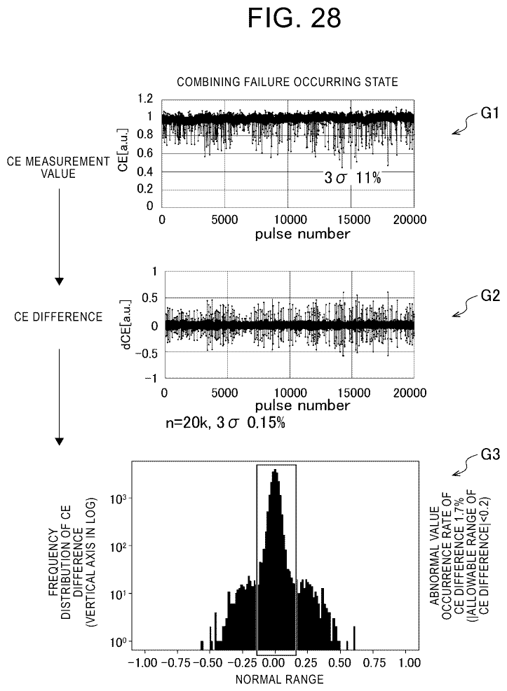

FIG. 28 is a graph showing an example of the CE measurement value, the CE difference, and a frequency distribution of the CE difference in a case that the combining failure of the DL is occurring. In a graph G1 shown in the upper stage of FIG. 28, the horizontal axis represents the pulse number and the vertical axis represents the CE measurement value in an arbitrary unit. In a graph G2 shown in the middle stage of FIG. 28, the horizontal axis represents the pulse number and the vertical axis represents the CE difference in an arbitrary unit. A graph G3 shown in the lower stage of FIG. 28 is a frequency distribution (histogram) of the CE difference. The vertical axis of the graph G3 is expressed in logarithmic (LOG) representation.

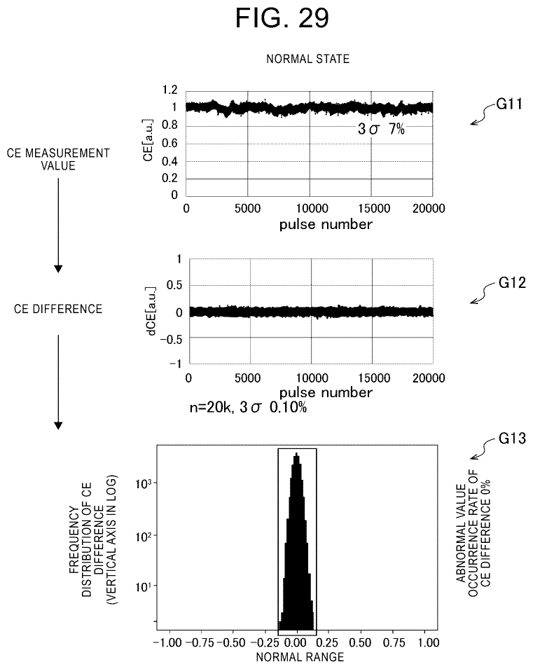

Further, FIG. 29 is a graph showing an example of the CE measurement value, the CE difference, and the frequency distribution of the CE difference in a case that the combining of the DL is normal. A graph G11 shown in the upper stage of FIG. 29 shows the CE measurement value, a graph G12 shown in the middle stage shows the CE difference, and a graph G13 shown in the lower stage shows the frequency distribution of the CE difference. The horizontal axis and the vertical axis of each graph are similar to those of the corresponding graph in FIG. 28.

As is apparent from a comparison between FIGS. 28 and 29, when a combining failure occurs, variations in the CE measurement value and the CE difference measured in pulse order are larger than those in the normal state. In the example of FIG. 29, 3σ of the CE measurement value in the normal state is 7%. On the other hand, in the example of FIG. 28, 3σ of the CE measurement value at the time of occurrence of the combining failure is 11%. Further, 3σ of the CE difference in the normal state shown in the example of FIG. 29 is 0.1%, whereas 3σ of the CE difference at the time of occurrence of combining failure shown in the example of FIG. 28 is 0.15%.

As shown in the lower stages of FIGS. 28 and 29, for example, when a range in which the absolute value of the CE difference is less than 0.2 (−0.2<dCE<−0.2) is set as the allowable range (normal range) of the CE difference, the abnormal value occurrence rate of the CE difference at the normal state shown in the example of FIG. 29 is 0%, whereas the abnormal value occurrence rate of the CE difference at the time of occurrence of the combining failure shown in the example of FIG. 28 is 1.7%.

Thus, by controlling the Duty of the piezoelectric element 47 using the index for evaluating the variation of the CE, such as 3σ of the CE measurement value, 3σ of the CE difference, or the abnormal value occurrence rate of the CE difference reflecting the DL combining state, it is possible to suppress the occurrence of the DL combining failure state which is difficult to detect by the DL passage interval σ. The index for evaluating the variation of the CE is an example of the “abnormal value occurrence rate of the difference between the ratio of the EUV energy and the laser energy and the past ratio thereof” in the present disclosure.

### 4.4 Effect

According to the EUV light generation apparatus 10B of the second embodiment, setting to the piezoelectric Duty with which the EUV performance deterioration occurs is prevented by the operation of the DL combining control based on the EUV light, thereby the EUV energy stability is improved. Further, fragment generation is also suppressed.

### 5. Combination of Indices Determining Prohibited Duty

In the first embodiment, the prohibited Duty is determined using the DL position deviation as an index. In the second embodiment, the prohibited Duty is determined using the abnormal value occurrence rate of the CE difference which is an index value for evaluating the variation of the CE. Here, the prohibited Duty band may be set using a combination of a plurality of indices.

### 6. Electronic Device Manufacturing Method

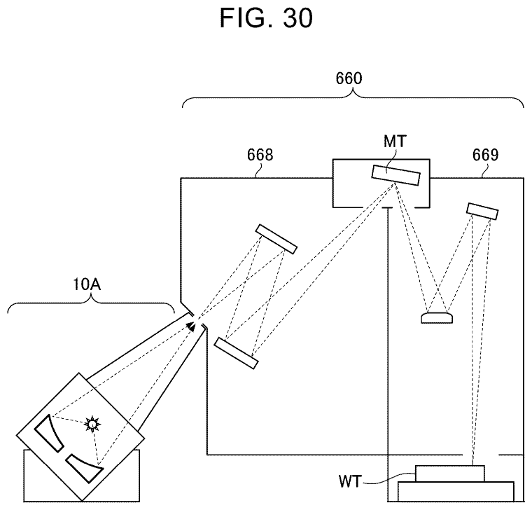

FIG. 30 is a diagram schematically showing the configuration of an exposure apparatus 660 connected to the EUV light generation apparatus 10A. The exposure apparatus 660 includes a mask irradiation unit 668 and a workpiece irradiation unit 669. The mask irradiation unit 668 illuminates, via a reflection optical system, a reticle pattern of a reticle table MT with EUV light incident from the EUV light generation apparatus 10A. The workpiece irradiation unit 669 images the EUV light reflected by the reticle table MT onto a workpiece (not shown) placed on the workpiece table WT through a reflection optical system. The workpiece is a photosensitive substrate such as a semiconductor wafer on which photoresist is applied.

The exposure apparatus 660 synchronously translates the reticle table MT and the workpiece table WT to expose the workpiece to the EUV light reflecting the reticle pattern. Through the exposure process as described above, a device pattern is transferred onto the semiconductor wafer, thereby an electronic device can be manufactured. In the configuration shown in FIG. 30 as well, the EUV light generation apparatus 10B may be used instead of the EUV light generation apparatus 10A.

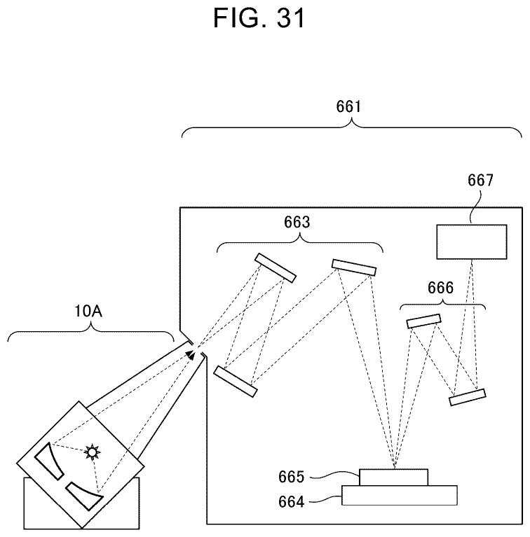

FIG. 31 is a diagram schematically showing the configuration of an inspection apparatus 661 connected to the EUV light generation apparatus 10A. The inspection apparatus 661 includes an illumination optical system 663 and a detection optical system 666. The illumination optical system 663 reflects the EUV light incident from the EUV light generation apparatus 10A to illuminate a reticle 665 placed on a reticle stage 664. Here, the reticle 665 conceptually includes a mask blanks before a pattern is formed. The detection optical system 666 reflects the EUV light from the illuminated reticle 665 and forms an image on a light receiving surface of a detector 667. The detector 667 having received the EUV light obtains the image of the reticle 665. The detector 667 is, for example, a time delay integration (TDI) camera.

Defects of the reticle 665 are inspected based on the image of the reticle 665 obtained by the above-described inspection process, and a reticle suitable for manufacturing an electronic device is selected using the inspection result. Then, the electronic device can be manufactured by exposing and transferring the pattern formed on the selected reticle onto the photosensitive substrate using the exposure apparatus 660. In the configuration shown in FIG. 31 as well, the EUV light generation apparatus 10B may be used instead of the EUV light generation apparatus 10A.

### 7. Processor

The processor such as the EUV light generation processor 24 may be physically configured as hardware to execute various processes included in the present disclosure. For example, the processor may be a computer including a memory that stores a control program defining the various processes and a processing device that executes the control program. The control program may be stored in one memory, or may be stored separately in a plurality of memories at physically separate locations, and the various processes included may be defined by the control program as an aggregation thereof. The processing device may be a general-purpose processing device such as a CPU or a special-purpose processing device such as a GPU.

Alternatively, the processor may be programmed as software to execute the various processes included in the present disclosure. For example, the processor may be implemented in a dedicated device such as an ASIC or a programmable device such as an FPGA.

The various processes included in the present disclosure may be executed by one computer, one dedicated device, or one programmable device, or may be executed by cooperation of a plurality of computers, a plurality of dedicated devices, or a plurality of programmable devices at physically separate locations. The various processes may be executed by a combination including at least any two of: one or more computers, one or more dedicated devices, and one or more programmable devices.

### 8. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. An extreme ultraviolet: generation apparatus configured to generate extreme ultraviolet light by irradiating a droplet with laser light, comprising:
a tank configured to store a target substance in a liquid state;
a nozzle configured to output the target substance stored in the tank;
a piezoelectric element configured to apply vibration reflecting an electric signal to the target substance to be output from the nozzle to generate the droplet of the target substance;
a first sensor configured to measure a passage interval of the droplets output from the nozzle;
a second sensor configured to measure a parameter related to the droplet; and
a processor configured to set a prohibited band of a duty of the electric signal based on data in which the duty and the parameter at the duty are associated with each other, and set the duty of the electric signal to be applied to the piezoelectric element while avoiding the prohibited band.

2. The extreme ultraviolet light generation apparatus according to claim 1,
wherein the processor outputs the electric signal of the duty to the piezoelectric element such that variation in the passage interval is reduced while avoiding the prohibition band.

3. The extreme ultraviolet light generation apparatus according to claim 1,
wherein the processor calculates a first approximate straight line in correlation between the duty and variation in the passage interval, and changes the duty in a direction of decreasing the variation in the passage interval based on a gradient of the first approximate straight line.

4. The extreme ultraviolet light generation apparatus according to claim 1,
wherein the second sensor is a sensor that detects a passage position of the droplet, and
the parameter includes a deviation of the passage position from a target position thereof.

5. The extreme ultraviolet light generation apparatus according to claim 4,
wherein the second sensor includes an image sensor, and is arranged at a position from which a trajectory of the droplet is observed.

6. The extreme ultraviolet light generation apparatus according to claim 4,
wherein the processor stores the duty with which the deviation is equal to or more than a first threshold as a prohibited duty belonging to the prohibited band.

7. The extreme ultraviolet light generation apparatus according to claim 1,
wherein the processor outputs the electric signal of the duty such that the parameter satisfies a predetermined condition to the piezoelectric element while avoiding the prohibited band.

8. The extreme ultraviolet light generation apparatus according to claim 1,
wherein the second sensor includes an EUV energy sensor configured to detect EUV energy of extreme ultraviolet light generated by irradiating the droplet with the laser light, and a laser energy sensor configured to measure laser energy of the laser light, and
the parameter is an index based on a ratio of the EUV energy and the laser energy.

9. The extreme ultraviolet light generation apparatus according to claim 8,
wherein the parameter is an abnormal value occurrence rate of a difference between a ratio of the EUV energy and the laser energy and a past ratio thereof.

10. The extreme ultraviolet light generation apparatus according to claim 9,
wherein the processor stores the duty with which the abnormal value occurrence rate of the difference is equal to or more than a second threshold as a prohibited duty belonging to the prohibited band.

11. The extreme ultraviolet light generation apparatus according to claim 1,
wherein the processor calculates a second approximate straight line in correlation between the duty and the parameter, and changes the duty in a direction of improving performance indicated by the parameter based on a gradient of the second approximate straight line.

12. A droplet generation control method with an extreme ultraviolet light generation apparatus configured to generate extreme ultraviolet light by irradiating a droplet with laser light, comprising:
generating the droplet of a target substance by applying an electric signal to a piezoelectric element to apply vibration reflecting the electric signal to the target substance in a liquid state to be output from the nozzle;
measuring a passage interval of the droplets output from the nozzle by a first sensor;
measuring a parameter related to the droplet by a second sensor different from the first sensor;
setting a prohibited band of a duty of the electric signal based on data in which the duty and the parameter at the duty are associated with each other; and
setting the duty of the electric signal to be output to the piezoelectric element while avoiding the prohibited band.

13. An electronic device manufacturing method, comprising:
generating extreme ultraviolet light using an extreme ultraviolet light generation apparatus;
outputting the extreme ultraviolet light to an exposure apparatus; and
exposing a photosensitive substrate to the extreme ultraviolet light in the exposure apparatus to manufacture an electronic device,
the extreme ultraviolet light generation apparatus being configured to generate the extreme ultraviolet light by irradiating a droplet with laser light, and including:
a tank configured to store a target substance in a liquid state;
a nozzle configured to output the target substance stored in the tank;
a piezoelectric element configured to apply vibration reflecting an electric signal to the target substance to be output from the nozzle to generate the droplet of the target substance;
a first sensor configured to measure a passage interval of the droplets output from the nozzle;
a second sensor configured to measure a parameter related to the droplet; and
a processor configured to set a prohibited band of a duty of the electric signal based on data in which the duty and the parameter at the duty are associated with each other, and set the duty of the electric signal to be applied to the piezoelectric element while avoiding the prohibited band.

14. An electronic device manufacturing method, comprising:
generating extreme ultraviolet light using an extreme ultraviolet light generation apparatus;
inspecting a defect of a reticle by irradiating the reticle with the extreme ultraviolet light;
selecting a reticle using a result of the inspection; and
exposing and transferring a pattern formed on the selected reticle onto a photosensitive substrate,
the extreme ultraviolet light generation apparatus being configured to generate the extreme ultraviolet light by irradiating a droplet with laser light, and including:
a tank configured to store a target substance in a liquid state;
a nozzle configured to output the target substance stored in the tank;
a piezoelectric element configured to apply vibration reflecting an electric signal to the target substance to be output from the nozzle to generate the droplet of the target substance;
a first sensor configured to measure a passage interval of the droplets output from the nozzle;
a second sensor configured to measure a parameter related to the droplet; and
a processor configured to set a prohibited band of a duty of the electric signal based on data in which the duty and the parameter at the duty are associated with each other, and set the duty of the electric signal to be applied to the piezoelectric element while avoiding the prohibited band.
